(19) United States
(12) Patent Application Publication
(10) Pub. No.: US 2004/0156053 A1
(43) Pub. Date: Aug. 12, 2004

(54) Method and arrangement for the depth-resolved detection of specimens

(75) Inventors: Ralf Wolleschensky, Schoeten (DE); Michael Kempe, Kunitz (DE)

Correspondence Address: Gerald H. Kiel, Esq., Reed Smith LLP, 599 Lexington Avenue, New York, NY, 10022, US

(73) Assignee: Carl Zeiss Jena GmbH, Jena (DE)

(21) Appl. No.: 10/770,828

(22) Filed: Feb. 2, 2004

Related U.S. Application Data
(63) Continuation of application No. 10/077,630, filed on Feb. 15, 2002, now abandoned.

(30) Foreign Application Priority Data
Oct. 9, 2001 (DE) 101 50 934.0

(51) Int. Cl. G01B 9/02

(52) U.S. Cl. 356/485

(57) ABSTRACT

An arrangement comprises an optical modulator for fast modulation which is provided in an interferometer arm of the interferometer arrangement for heterodyne detection. In one aspect, the modulator is used simultaneously for switching and/or beam attenuation in a laser scanning microscope. A method for operation of the arrangement by using such laser scanning microscope for single-photon and/or multiphoton fluorescence and using the heterodyne detection for referencing the fluorescence to regions deep in the specimen is also disclosed.

### CROSS-REFERENCE TO RELATED APPLICATIONS

This is a Continuation Application under 37 C.F.R. 1.53(b). Priority is hereby claimed under 35 U.S.C. §120 to application Ser. No. 10/077,630 filed Feb. 15, 2002, which claims priority of German application No. 101 50 934.0, filed Oct. 9, 2001, the complete disclosure of which is hereby incorporated by reference. The entire disclosures of all applications above are hereby incorporated by reference herein.

### BACKGROUND OF THE INVENTION

1. Field of the Invention

The invention is directed particularly to a method and an arrangement in microscopy, in particular laser scanning microscopy, for the investigation and manipulation of predominantly biological specimens, preparations and associated components.

2. Description of the Related Art

A typical area of application of light microscopy for the investigation of biological preparations is fluorescence microscopy (Pawley, “Handbook of Biological Confocal Microscopy”; Plenum Press 1995). For this purpose, determined dyes are used for specific labeling of cell parts.

The irradiated photons having a determined energy excite the dye molecules, through the absorption of a photon, from the ground state to an excited state. This excitation is usually referred to as single-photon absorption (FIG. 1a). The dye molecules excited in this way can return to the ground state in various ways. In fluorescence microscopy, the most important transition is by emission of a fluorescence photon. Because of the Stokes shift, there is generally a red shift in the wavelength of the emitted photon in comparison to the excitation radiation; that is, it has a greater wavelength. Stokes shift makes it possible to separate the fluorescent radiation from the excitation radiation.

The fluorescent light is split off from the excitation radiation by suitable dichroic beam splitters in combination with blocking filters and is observed separately. This makes it possible to show individual cell parts that are dyed with different dyes. In principle, however, multiple parts of a preparation can also be dyed simultaneously with different dyes which bind in a specific manner (multiple fluorescence). Special dichroic beam splitters are used again to distinguish the fluorescence signals emitted by the individual dyes.

In addition to excitation of dye molecules with a high-energy photon (single-photon absorption), excitation with a plurality of lower-energy photons is also possible (FIG. 1b). In this case, the specimen interaction is nonlinear. The sum of energies of the single photons corresponds approximately to that of the high-energy photon. This type of excitation of dyes is known as multiphoton absorption (Corle, Kino, “Confocal Scanning, Optical Microscopy and Related Imaging Systems”; Academic Press 1996). FIG. 1b shows excitation by means of the simultaneous absorption of two photons in the near infrared wavelength region. However, the dye emission is not influenced by this type of excitation, i.e., the emission spectrum undergoes a negative Stokes shift in multiphoton absorption; that is, it has a smaller wavelength compared to the excitation radiation. The separation of the excitation radiation from the emission radiation is carried out in the same way as in single-photon excitation.

The prior art will be explained more fully in the following by way of example with reference to a confocal laser scanning microscope (LSM) (FIG. 2).

An LSM is essentially composed of four modules: light source L, scan module S, detection unit DE and microscope M. These modules are described more fully in the following. In addition, reference is had to DE19702753A1 and U.S. Pat. No. 6167173.

Lasers with different wavelengths are used in an LSM for specific excitation of different dyes in a preparation. The choice of excitation wavelength is governed by the absorption characteristics of the dyes to be examined. The excitation radiation is generated in the light source module L. Various lasers A-D (argon, argon/krypton, Ti:Sa lasers) are used for this purpose. Further, the selection of wavelengths and the adjustment of the intensity of the required excitation wavelength is carried out in the light source module L, e.g., using an acousto-optic modulator. The laser radiation subsequently reaches the scan module S via a fiber or a suitable mirror arrangement. The laser radiation generated in the light source L is focused in the preparation (specimen 3) in a diffraction-limited manner by the objective (2) through the scanner, scan optics and tube lens. The focus is moved in two dimensions in x-y direction over the specimen 3. The pixel dwell times when scanning over the specimen 3 are mostly in the range of less than one microsecond to several seconds.

In confocal detection (descanned detection) of fluorescent light, the light emitted from the focal plane (specimen 3) and from the planes located above and below the latter reaches a dichroic beam splitter (MDB) via the scanner. This dichroic beam splitter separates the fluorescent light from the excitation light. The fluorescent light is subsequently focused on a diaphragm (confocal diaphragm/pinhole) (PH1,2,3,4) located precisely in a plane conjugate to the focal plane of the objective 2 via dichroic beam splitters DBS 1-3 and pinhole optics. In this way, fluorescent light components outside of the focus are suppressed. The optical resolution of the microscope can be adjusted by varying the size of the diaphragm. Another dichroic blocking filter (EF1-4) which again suppresses the excitation radiation is located behind the diaphragm. After passing the blocking filter, the fluorescent light is measured by a point detector (PMT 1-4).

When using multiphoton absorption, the excitation of the dye fluorescence is carried out in a small volume in which the excitation intensity is particularly high. This area is only negligibly larger than the detected area when using a confocal arrangement. Accordingly, a confocal diaphragm can be dispensed with and detection can be carried out via T-PMT, PMT 5 directly following the objective in the detection direction or on the side remote of the objective (nondescanned detection).

In another arrangement (not shown) for detecting a dye fluorescence excited by multiphoton absorption, descanned detection is carried out again, but this time the pupil of the objective is imaged in the detection unit by the pinhole optics PH (nonconfocal descanned detection).

From a three-dimensionally illuminated image, only the plane (optical section) coinciding with the focal plane of the objective is reproduced by the above-mentioned detection arrangements in connection with corresponding single-photon absorption or multiphoton absorption. By recording a plurality of optical sections in the x-y plane at different depths z of the specimen, a three-dimensional image of the specimen can be generated subsequently in computer-assisted manner.

Accordingly, the LSM is suitable for the investigation of thick preparations. The excitation wavelengths are determined by the utilized dye with its specific absorption characteristics. Dichroic filters adapted to the emission characteristics of the dye ensure that only the fluorescent light emitted by the respective dye will be measured by the point detector.

A disadvantage in the confocal LSM method according to the prior art consists in that the depth of penetration into a biological preparation is limited to a maximum of approximately 500 μm due to the high signal losses on the excitation side and detection side (see FIG. 4(1)). Accordingly, for instance, in a thick preparation, only the outer shell of the object can be investigated by means of the LSM.

The principle of heterodyne detection in scanning microscopy was presented in T. Sawatari, “Optical heterodyne scanning microscope”, Applied Optics 12 (1973), 2768-2772. The optical arrangement essentially comprises a Michelson interferometer. Light from a light source (see FIG. 3A) generally having a broad spectral band is split into two partial beams at a beam splitter (BS). One partial beam scans the specimen in the object beam path. The second partial beam serves as a reference arm. The light which is backscattered from the specimen is superimposed interferometrically at the BS with light of the reference beam path. The optical path length between the two partial beams can be balanced or equalized by displacing the mirror M along D. The light in the reference beam path is frequency-shifted relative to the light in the object beam path. This can be carried out by phase modulation by means of a special component or by moving the mirror M (i.e., by means of a Doppler shift). The detector measures the signal shown in FIG. 3B as a function of the displacement D. The signal S is demodulated to obtain the envelope of the interference signal which is determined by the spectral characteristic of the light source, the dispersion imbalance in the interferometer arms and the numerical aperture of the microscope objective in the object beam path. A demodulation of this kind can be carried out, e.g., in a phase-insensitive manner, by rectification and subsequent lowpass filtering. Alternatively, the demodulation can also be carried out in a phase-sensitive manner in a lock in the amplifier after rectification of the signal, the lock-in being triggered by the driver signal of the phase modulation as reference. Analysis of a laser scanning microscope with heterodyne detection is described in M. Kempe and W. Rudolph, “Analysis of heterodyne and confocal microscopy for illumination with broad-bandwidth light”, J. of Mod. Opt. 43 (1996), 2189-2204. With a complete dispersion balance, a light source with a Gaussian spectrum with bandwidth δω and center frequency ω₀ and an objective with a half-aperture angle α and a laterally homogeneous thin object gives as envelope:

$$S ( z ) \approx 1 - \frac{2}{3} {k}^{2} {z}^{2} ⌊ {sin}^{4} ( α / 2 ) + \frac{δ ω}{{ω}_{0}} ⌋ . \qquad ( 1 )$$

For high numerical apertures and a small bandwidth of light, the optical resolution is characterized by the confocal depth discrimination. In general, this is improved by heterodyne detection.

Heterodyne detection has the following advantages over conventional detection in a confocal incident light LSM:

There is optical amplification of the backscattered ballistic light. Shot-noise-limited detection with respect to the signal can be carried out in this way (H. P. Yuen and V. W. S. Chan, “Noise in homodyne and heterodyne detection”, Optics Letters 8 (1983), 177-179).

With broadband light, the interferometric superposition of object radiation and reference radiation leads to an improvement of the spatial resolution in cases where the confocal depth resolution is poorer than the coherence length of the light due to small NA or aberrations (M. Kempe and W. Rudolph, Scanning microscopy through thick layers based on linear correlation”, Optics Letters 19 (1994), 1919-1921).

The same effect leads to the suppression of the backscattered, nonballistic light (coherence gate in addition to the spatial gate by means of the inherently confocal detection) (Joseph A. Izatt, Michael R. Hee, Gabrielle M. Owen, Eric A. Swanson, James G. Fujimoto, “Optical coherence microscopy in scattering media”, Optics Letters 19 (1994), 590-592; J. M. Schmitt and K. Ben-Letaief, “Efficient Monte Carlo simulation of confocal microscope in biological tissue”, JOSA A 13 (1996), 952-961; M. Kempe, W. Rudolph, E. Welsch, “Comparative study of confocal and heterodyne microscopy for imaging through scattering media”, JOSA A 13 (1996), 46-52).

Heterodyne detection according to the prior art is disadvantageous in that, in contrast to the LSM, a high penetration depth in a biological specimen is realized, but the specimen can only be investigated in reflection. It is impossible to investigate the specimen in fluorescence. However, penetration depths in highly scattering biological preparations of several millimeters is known from the literature (see RP in FIG. 4(2)). Therefore, it is possible to examine an embryo with three-dimensional resolution during its phase of development, for example.

### SUMMARY OF THE INVENTION

The invention may provide a method by which dynamic processes can be investigated in particular during the growth of biological preparations. This is met by arrangements and methods according to the independent patent claims. Preferred further developments are indicated in the dependent claims.

According to the invention, regions which can be examined by the LSM by fluorescence or reflection can be referenced to regions RP deep in the object by means of heterodyne detection (HTD) (see FIG. 4) by producing a reference of a confocal LSM image to the HTD structure.

### BRIEF DESCRIPTION OF THE DRAWINGS

In the drawings:

FIG. 1A shows in representational form single photon absorption of energy by a sample;

FIG. 1B shows in representational form multiphoton absorption of energy by a sample;

FIG. 2 illustrates in schematic form a confocal laser scanning microscope;

FIG. 3A shows a Michelson interferometer in representational form;

FIG. 3B shows the resulting signal of the interferometer in graphical representation;

FIG. 4 shows in representational form the depth of representation in a sample according to certain prior art arrangements;

FIG. 5 schematically shows an arrangement in accordance with the invention;

FIG. 6 schematically shows an arrangement using two Hamamatsu photomultipler tubes for detection of the heterodyne signal;

FIG. 7 shows the signal-to-noise ratio for an assumed laser noise and for different values of detector noise;

FIG. 8 schematically shows a laser scanning microscope incorporating the construction of FIG. 5;

FIG. 9 shows another possibility for incorporating the construction according to FIG. 5 in a confocal laser scanning microscope;

FIG. 10 schematically illustrates construction of a dispersion compensation unit with an LSM; and

FIG. 11 schematically illustrates another construction in accordance with the invention utilizing a spatial light modulator in the beam path.

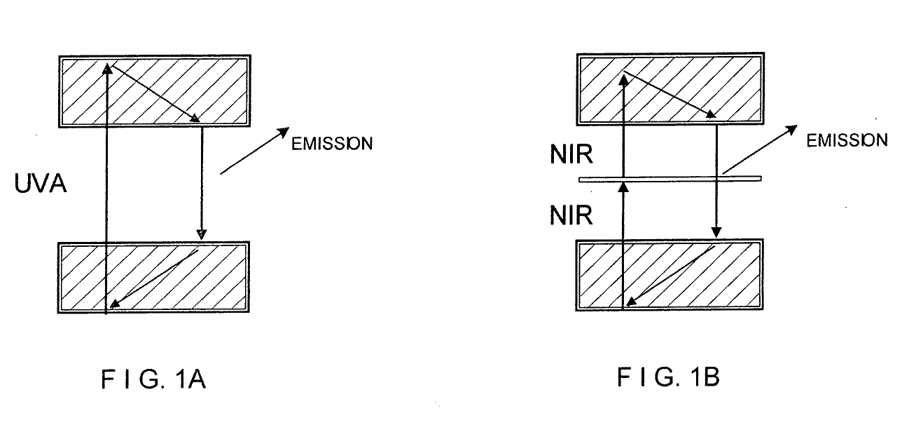

### DESCRIPTION OF THE PREFERRED EMBODIMENTS

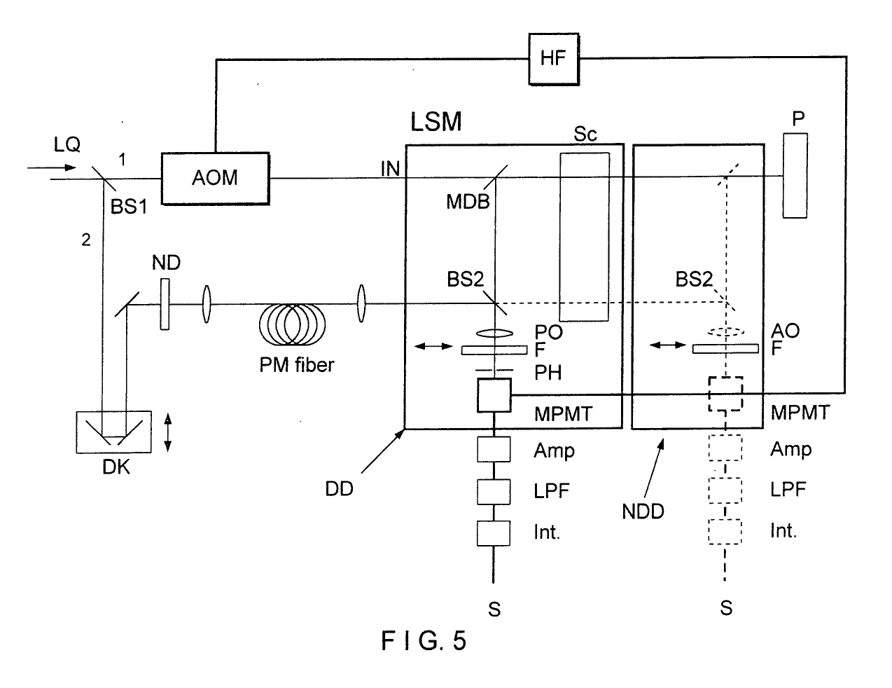

The arrangement according to the invention is shown schematically in FIG. 5. In this case, it involves a Mach-Zehnder interferometer. In principle, without limiting, the Mach-Zehnder interferometer can also be replaced by different types of interferometers according to the prior art such as Michelson interferometers. The short-coherent light of the light source LQ, for example, a short pulse laser, is divided in the arrangement into two partial beams 1, 2 by means of the beam splitter BS1.

The partial beam 1 passes through an acousto-optic modulator AOM (or AOTF) into a laser scanning microscope LSM according to the prior art. In the LSM, the light is imaged in the specimen P via the main beam splitter MDB and the scanners SC. The specimen can be scanned vertical to the optical axis in two directions X, Y by means of the scanners. A Z-coordinate is ensured by the Z-adjustment of the specimen. The light backscattered from the specimen is directed from the MDB in the direction of the beam splitter BS2 and in the detection direction. For this purpose, the MDB is arranged in front of the scanner (SC) for nondescanned detection (NDD), shown in dashes, and after the scanner (SC) for descanned detection (DD). The partial beam 2 arrives on BS2 via dispersion compensating means DK, means for adapting the intensity ND (adaptation of optical amplification) and a delay path, e.g., a polarization-maintaining (PM) fiber. The two partial beams are superimposed interferometrically at BS2. By means of the delay path, a rough equalization of the optical path lengths of the two partial beams is carried out in order to compensate for the action of the optics in the microscope beam path 1 relative to the beam path 2. The precision matching of the path length is ensured by DK, so that the optical paths and, advantageously, also the dispersion are identical for both partial beams, and an interferometric superposition of the two partial beams is carried out. As is shown in FIG. 5, DK can be carried out by means of a retroreflector or by the arrangement with a spatial light modulator (SLM) which will be described below. The precision matching is required, for example, when changing the objective or to compensate for the dispersion in the object. BS1 and BS2 are designed in such a way that the partial beam 1 travels in the direction of the specimen or, after interaction in the object, to the detector MPMT as efficiently as possible. For this purpose, only a small portion, preferably less than 5%, of the radiation is deflected through BS1 in the direction of the beam path 2 in order to conduct a high proportion of radiation to the specimen.

Preferably, BS2 is designed in such a way that as much of the light from the specimen as possible arrives at the detector (preferably more than about 99%) for increasing the detection sensitivity.

In descanned detection (DD), pinhole optics PO which are focused on a detector MPMT through a confocal pinhole PH are arranged after BS2. The pinhole serves to suppress scattered light and light from outside the confocal focus. This prevents saturation of the detector by scattered light. In heterodyne detection, however, the confocal diaphragm can preferably be dispensed with, e.g., in a nondescanned beam path (NDD). The imaging of the partial beam 1 on the MPMT in nondescanned detection NDD is carried out with optics AO. In nondescanned detection NDD, the reference beam must also run over the scanners in addition, so that both beam paths can be spatially superimposed again at BS2.

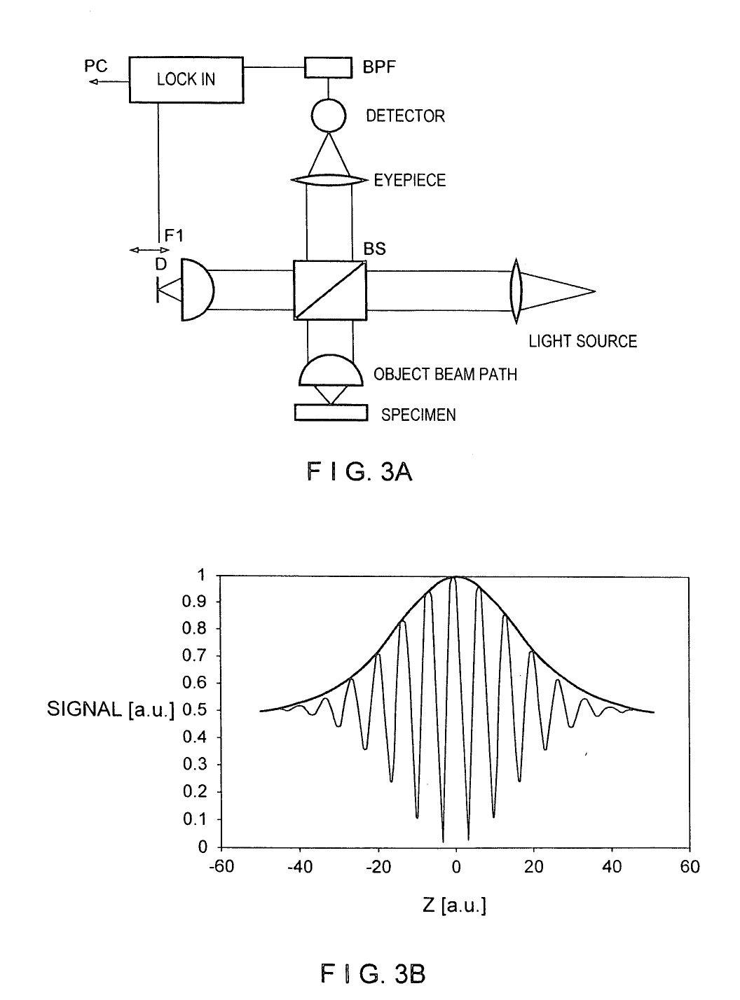

In addition, an emission filter F can also be swiveled in in front of the MPMT. This emission filter F is used for the detection of fluorescence signals with the MPMT. In the LSM, the AOM is used for attenuation of the partial beam 1. For this purpose, a standing acousto-optical wave—a Bragg grating—is generated in the AOM. The attenuation is carried out by changing the amplitude of the wave. The first diffraction order of light arrives at the Bragg grating for coupling into the LSM. The index of refraction in the crystal is changed periodically with the carrier frequency of the acousto-optical wave through the acousto-optical effect. The carrier frequency F1 is normally about 100 MHz. A fast phase displacement of partial beam 1 with respect to partial beam 2 is carried out by means of this change in the refractive index in the MHz range. This phase displacement corresponds to the fast modulation of the reference beam path through displacement D in FIG. 3 according to the prior art, that is, it replaces the latter. However, the frequency in this case is advantageously higher approximately by a factor of 1000 so that, in principle, the measurement times for recording a measurement point can be reduced by a factor of 1000.

The demodulation of the signal is carried out by means of a detector DE, e.g., a Hamamatsu H6573 photomultiplier (MPMT), which can be modulated by F1. This detector has a dynode which can be modulated at a frequency of up to 400 MHz, so that the sensitivity of the detector is changed with this frequency. The MPMT is modulated synchronously by the carrier frequency of the acousto-optical wave in the AOM. All optical signals which are modulated in the same phase with this frequency F1 with respect to time are accordingly converted, that is, demodulated, to a constant electric signal at the output of the MPMT. On the other hand, when a constant optical signal strikes the MPMT, it is converted in the photomultiplier into an electric signal that is modulated by F1. A short-pass filter LPF by which the modulated electric signals can be filtered out is arranged after the MPMT. Accordingly, the MPMT in combination with the LPF acts like a lock in the amplifier which is triggered by frequency F1. However, a modulation frequency Fl of up to 400 MHz can still be demodulated with this arrangement, since the maximum frequency is only limited by the MPMT.

The interference signal I measured at the MPMT is: I=B+H cos (2πF₁t), where B is the background and H is the signal amplitude of the heterodyne signal. The amplification of the MPMT can be described as follows: Gain.[1+cos (2πF₁ t+φ)], where φ is the relative displacement between the modulation frequency of the MPMT and the heterodyne signal. The amplified signal contains the following frequency components:

$$\begin{matrix}D C \text{:} & Gain \cdot [ B + \frac{H}{2} \cdot cos φ ] \\ at F1 \text{:} & Gain [ B \cdot cos ( 2 π \cdot F1 \cdot t + φ ) + H \cdot cos ( 2 π \cdot F1 \cdot t ) ] \\ at 2 \cdot {F}_{1} \text{:} & Gain \cdot [ \frac{H}{2} \cdot cos ( 4 π \cdot F1 \cdot t ) ] ,\end{matrix}$$

i.e., background B and signal H/2 are obtained after lowpass filtering with LPF. Two measurements must be carried out at different phase positions for separation, e.g., at φ=0° and 180°. The following is then obtained as DC differential signal:

$$S = Gain \cdot [ B + \frac{H}{2} \cdot cos ( 0 ° ) ] - Gain \cdot [ B + \frac{H}{2} \cdot cos ( 180 ° ) ] = Gain \cdot H$$

Alternatively, a highpass filtering can also be carried out, so that only the component at 2.F1 is obtained. However, this means that rectification and subsequent integration must then be carried out as in after a simple AC coupling of the original signal (detected without modulation).

Accordingly, the advantages of modulated detection (e.g., phase sensitivity) become noticeable only in the first case, i.e., when measured with different phase positions. The phase position can be carried out electronically with a phase adjuster which can be switched quickly (e.g., with respect to pixels, lines or frames). In addition, the switching can also be carried out by means of an additional phase plate which is switched in the reference beam path or object beam path. The phase plate can be arranged on a wheel for this purpose, so that fast pixel-exact switching processes can be carried out with this arrangement.

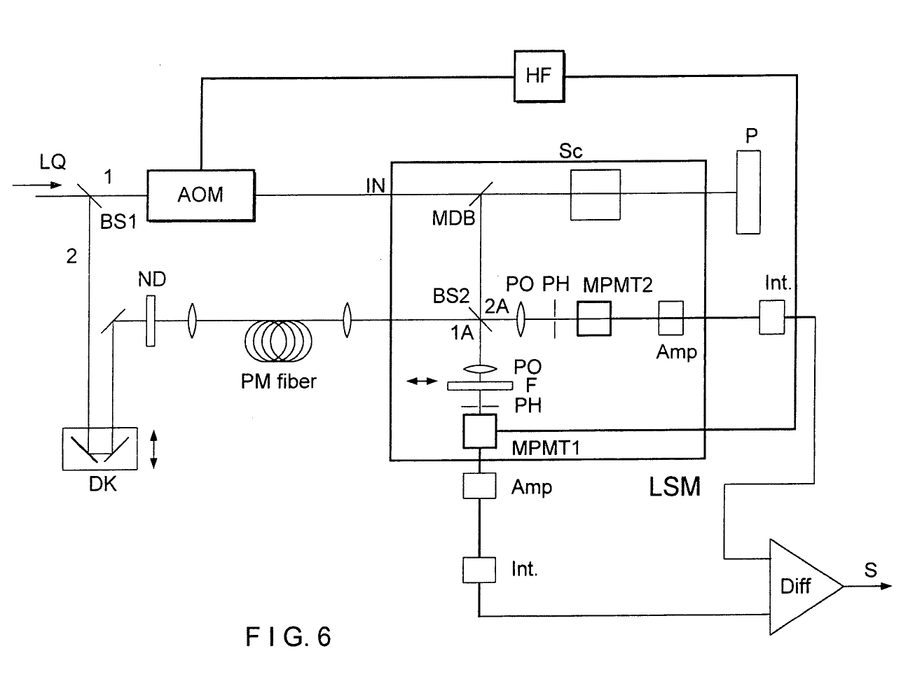

In another arrangement according to FIG. 6, two MPMTs are used for detection of the heterodyne signal. One MPMT1 is arranged optically in the same manner as described with reference to FIG. 5. The second MPMT2 is located at the second transmission port (beam path 2A) of BS2 (see FIG. 6). The signals of the two MPMTs 1 and 2 are subtracted after amplification and integration in a differential amplifier (Diff.). By means of this arrangement, the heterodyne signal A is obtained without background B. In another arrangement, not shown, instead of a second MPMT with mirrors, the light which would reach the MPMT2 is directed to the MPMT1 in addition. Further, instead of a second MPMT, a fast shutter can be arranged in front of the MPMT1, so that only the light from arm 1A and arm 2A is detected successively. The sequentially recorded signals at different phase positions are subsequently subtracted in the computer.

The specimen is scanned by means of the scanner, and the demodulated signal is summed over the pixel dwell time in an integrator Int. Since the integration time is usually substantially longer than the modulation frequency F1, the integrator acts as a short-pass filter and the LPF can be omitted.

A z-stack is generated by recording xy-images for different axial positions of the preparation. Displacement of the preparation is carried out by means of a table focusing device.

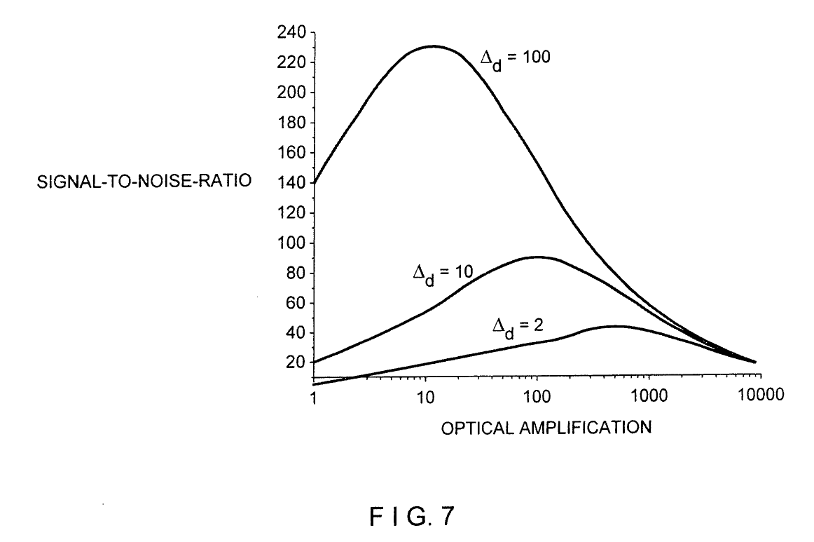

For purposes of interferometric superposition of the two partial beams, the reference beam is adapted with respect to polarization and beam parameters and, in addition, the output is adapted to the light reflected back from the object. The output of the reference beam must be dynamically adapted for this purpose depending on the object and for different depths of penetration in the same object. The polarization and beam parameters are adapted by means of the polarization-maintaining PM fiber or by the optics behind the fiber. By varying the polarization of the reference beam, e.g., by means of a λ/2 retardation plate or by rotating the PM fiber (by small angles), a polarization contrast can also be realized according to the prior art (J. F. de Boer, T. E. Milner, M. J. C. van Gemert, J. S. Nelson, “Two-dimensional birefringence imaging in biological tissue by polarization-sensitive optical coherence tomography”, Optics Letters 22 (1997), 934-936). Only a small percentage of the total output of the laser is coupled out via the beam splitter BS1 for the reference beam. This can be carried out, for example, by a glass plate which is adjusted close to the Brewster angle. Typically, only an output of <1% must be coupled in via BS2 for optimal optical amplification, so that the light reflected back from the specimen is attenuated only minimally. The precision matching of the output in the reference beam is adjusted in the vicinity of the modulation frequency depending on the output of the backreflected light and laser noise. In principle, the contribution to the signal-to-noise ratio (SNR) can be described as follows:

$$SNR = ⌊ \frac{l}{2 \sqrt{A}} + \frac{d}{2 \sqrt{A}} ⌋ , \qquad ( 2 )$$

where Δₗ is the relative laser noise (with modulation frequency within the detection bandwidth), Δ_{d} is the relative detector noise (NEP scaled to the light output lₛ reflected back from the specimen) and A is the optical amplification (output in the reference arm scaled to Iₛ). FIG. 7 shows the SNR for an assumed laser noise of 10⁻³ and for different values of the detector noise, from which an optical amplification of 10 to 1000 can be derived for small backreflected outputs in the pW range such as are typical for biological preparations. Under these circumstances, an optimal output in the reference arm is in the range of several nanowatts. The precision matching of the output in the reference arm is carried out by ND.

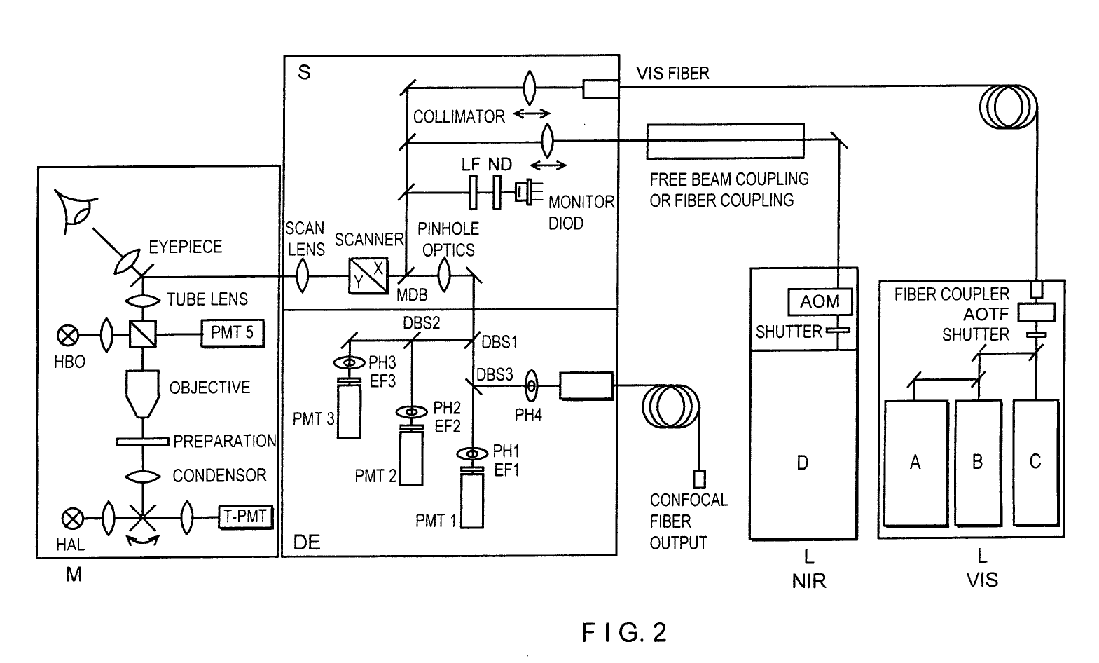

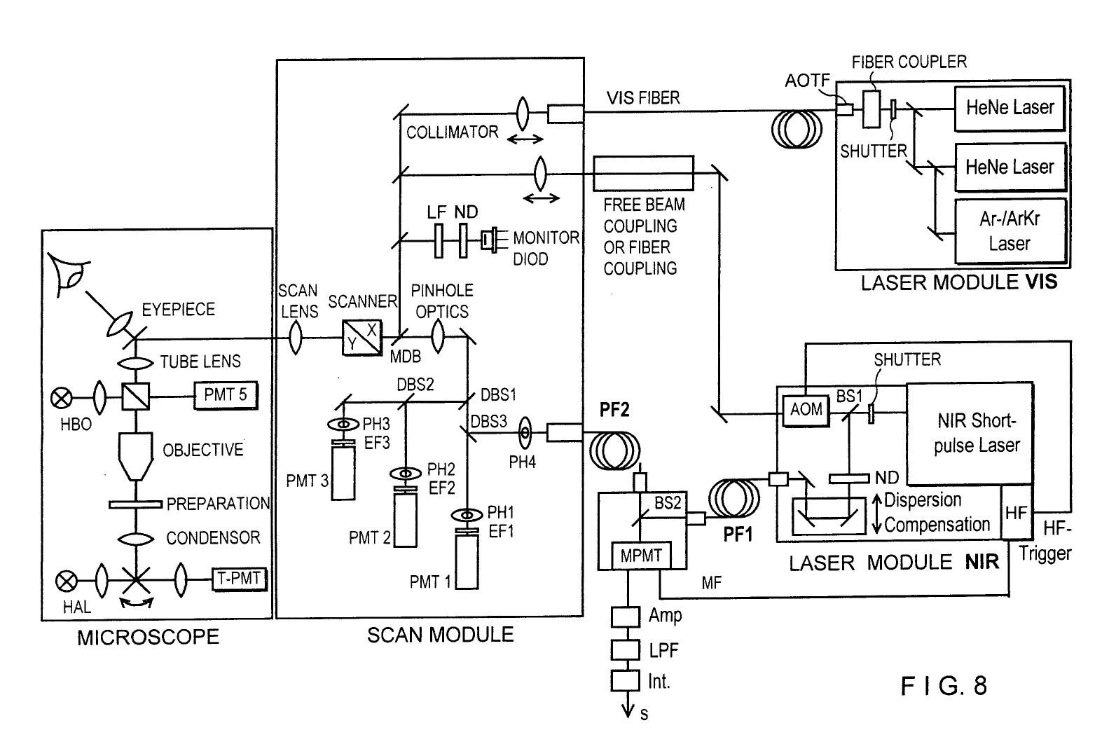

An arrangement for incorporating the construction shown schematically in FIG. 5 in a laser scanning microscope is shown schematically in FIG. 8. With this construction, it is possible to investigate the specimen with fluorescence and reflection simultaneously by means of heterodyne detection. The fluorescence can be generated by single-photon excitation or multiphoton excitation. The system essentially comprises the following component units: microscope, scan module and laser module. With respect to construction, the component units correspond to the prior art which was already discussed with reference to FIG. 2. In addition, there are the units mentioned with reference to FIG. 5. A short-pulse laser whose spectral bandwidth is about 10 nm and which is used in the LSM in addition for multiphoton excitation or SHG excitation serves as a spectrally broadband light source. The changes to the NIR laser module involve means for generating the reference beam, i.e., the beam splitting device BS1, ND, DK and the polarization-maintaining fibers PF1. The fluorescent light backscattered or radiated from the specimen reaches different secondary color splitters DBS, 1, 2, 3 via the MDB. By means of the DBS, the different fluorescence signals are split and fluorescence is separated from the backscattered excitation light of the NIR laser. The backscattered light reaches a polarization-maintaining fiber PF2 via the PH4. The light at the fiber outputs of PF1 and PF2 which corresponds to the object beam path (measurement beam path) and reference beam path of the interferometer is superimposed interferometrically and the MPMT measures the interference signal as was already explained with reference to FIG. 5. In this arrangement, the AOM is used for fast modulation with a frequency F1 and the attenuation of the intensity for excitation of a multiphoton fluorescence. The MPMT is modulated with F1 via connection MF. The detection of the reflection at the specimen and/or the fluorescence (multiphoton fluorescence and signal-photon fluorescence) is carried out according to the prior art in detectors PMT1 to PMT3, PMT5 and/or TPMT.

The fiber output PF2 can also be arranged behind one of the pinholes PH1-3 or nondescanned instead of PMT5 or in transmission instead of T-PMT.

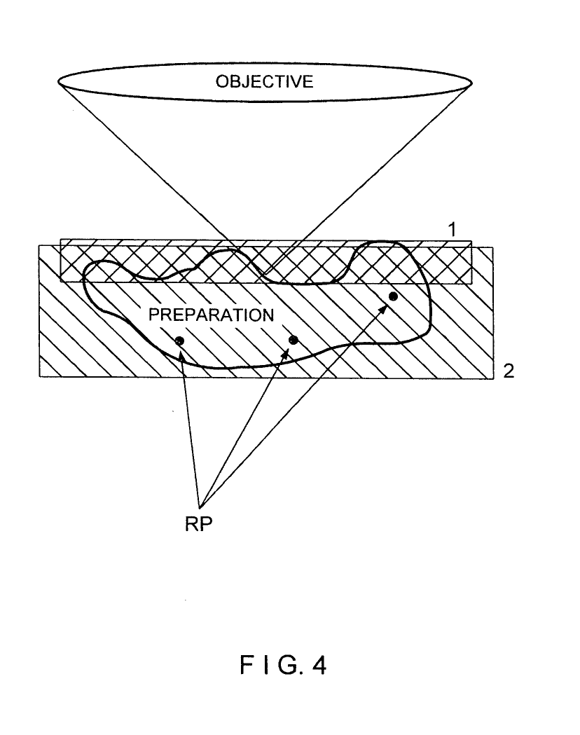

The advantage of the arrangement consists in the speed at which a reflection measurement signal can be generated, so that a synchronous recording with a fluorescence signal is possible. Therefore, it is possible to measure the light which is backscattered from the specimen and the fluorescent light simultaneously in a three-dimensionally resolved manner. This is useful particularly for investigating thick specimens over a long time period, since the depth of penetration to which a confocal fluorescent signal can be generated with the LSM is limited. For example, if the growth of an embryo is tracked over a longer time period (several days) (FIG. 4), only the outer shell (1) of the embryo can be investigated with a confocal LSM. However, by means of the OCT signal (2), the entire embryo can usually be observed in a three-dimensionally resolved manner due to the greater penetration depth. The outer shell (1) which is investigated with confocal fluorescence can be correlated with the reflection signal (2) by creating reference points RP and it is therefore possible to improve investigation of dynamic processes taking place in the shell. Further, the reference points can be used as marks, so that movements of the object or of the measurement construction during the recording of images over longer time periods or of three-dimensional image stacks can be corrected by means of these marks.

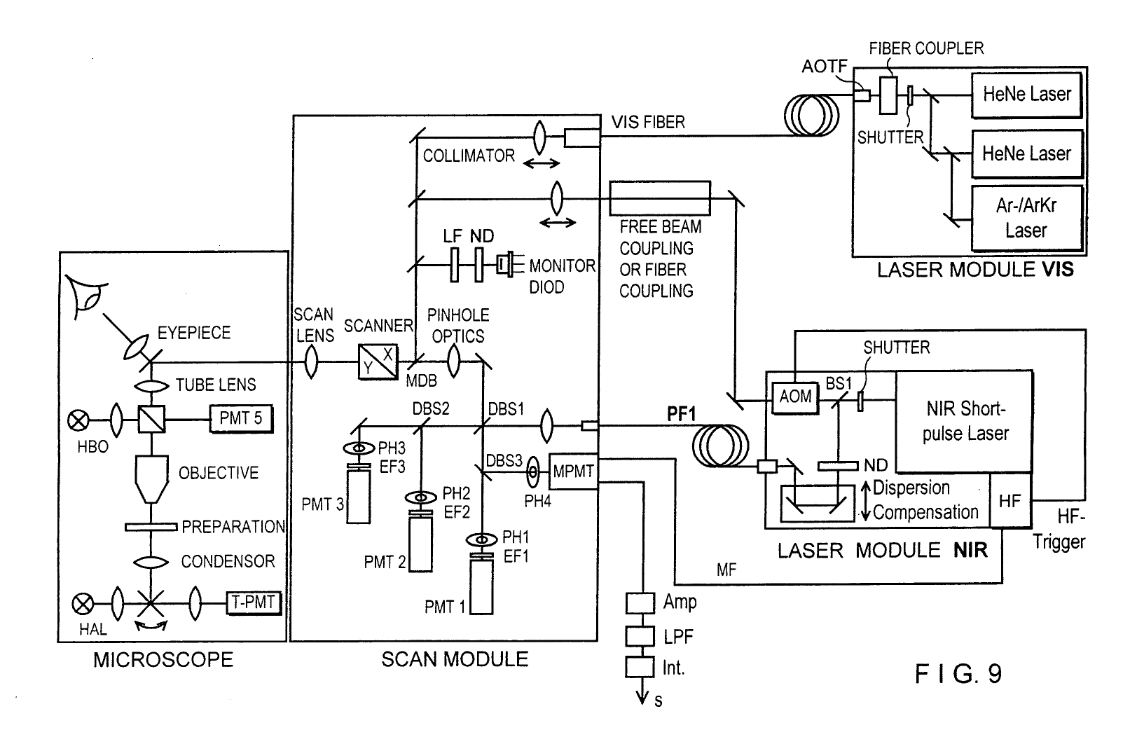

FIG. 9 shows another possibility for incorporating the construction according to FIG. 5 in a confocal laser scanning microscope. This corresponds essentially to the description with reference to FIG. 8. However, the MPMT is located directly behind the PH4. In this case, the beam splitter DBS1 serves as BS2 of the interferometer. PF2 and BS2 can be omitted in this arrangement, resulting in a higher efficiency of the beam path for imaging the light backscattered from the specimen onto the detector.

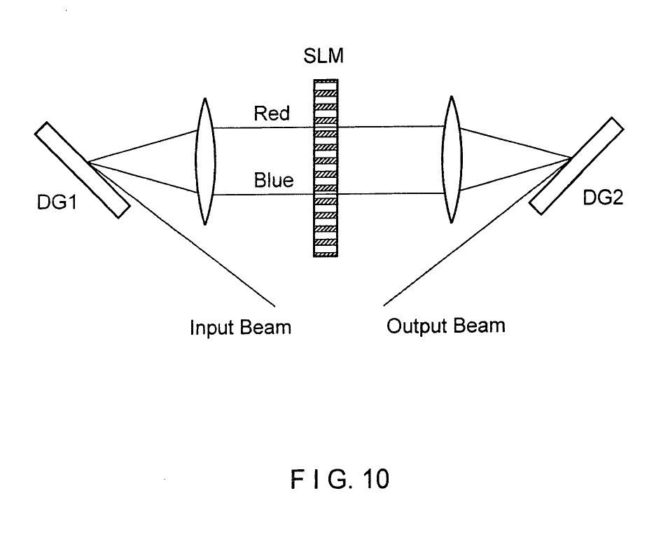

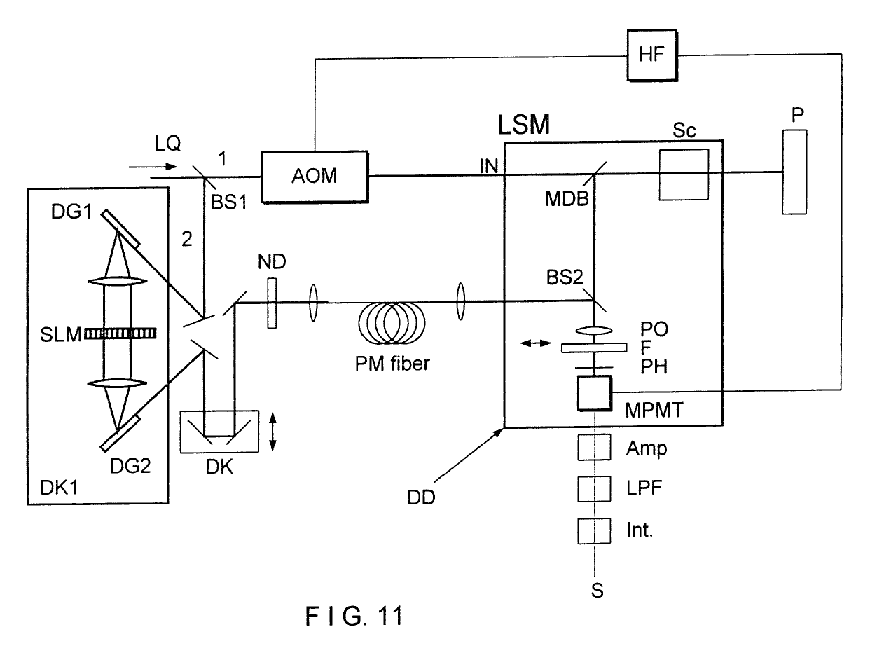

As was already mentioned above, the reference beam must be adapted to the beam path of the light backscattered from the specimen. This matching can be carried out, e.g., in another arrangement also by means of a spatial light modulator (SLM), e.g., Jenoptik SLM640/12) which is used in the beam path instead of or in addition to the dispersion compensation device DK as is shown in FIG. 11. The schematic construction of the dispersion compensation unit with an SLM is shown in FIG. 10. The spectrally broadband light of the light source is divided into its spectral components by a dispersive element, e.g., a dispersion grating DG1. Subsequently, a Fourier plane in which the spectral components are spatially separated is generated by a lens. The SLM is arranged in this plane. By controlling the individual elements, the phase positions of the spectral components can be influenced independent from one another by changing the index of refraction and different dispersions can accordingly be adjusted. Another lens and a DG2 are located after the SLM so that the individual spectral components are spatially superimposed again.

Reference is had to DE 19930532 A1 for a description of the operation.

The use of this arrangement for precision matching of the reference beam to the object beam has a number of advantages. For one, the optical path lengths can be equalized quickly without mechanical movement of elements. In addition, it is possible to adapt the total dispersion, and the entire spectral band of the light source is available for shaping the interference signal. In case the dispersion is not identical in the two partial beams at BS2, a narrowing of the spectral bandwidth of the light source takes place. This reduction of the bandwidth results in a worsened spatial resolution (see equation (1)). The adjustment of the SLM can be carried out, depending on the penetration depth and on the preparation that is used, with different algorithms according to the prior art (so-called evolution algorithms or iterative methods for parameter optimization). In addition, the pulse length for the object beam can be optimized by the same unit for efficient excitation of a multiphoton fluorescence as is described in DE 19930532 A1. An SLM DK1 of the type mentioned above is shown in the reference beam path in FIG. 11.

While the foregoing description and drawings represent the present invention, it will be obvious to those skilled in the art that various changes may be made therein without departing from the true spirit and scope of the present invention.

In the claims:

1. (Original) An arrangement comprising:
an interferometer arrangement;
an optical modulator for fast modulation being provided in an interferometer arm of said interferometer arrangement for heterodyne detection.

2. (Original) The arrangement according to claim 1, wherein the interferometer arrangement has a measurement arm and the modulator is arranged in said measurement arm of said interferometer.

3. (Original) The arrangement according claim 1, wherein the modulator is used simultaneously for switching and/or beam attenuation in a laser scanning microscope.

4. (Original) The arrangement according to claim 1, wherein the interferometer arrangement has a reference arm and the modulator is arranged in said reference arm of the interferometer and is the measurement arm of the illumination beam path of a laser scanning microscope.

5. (Original) The arrangement according to claim 1, wherein during a modulation by the modulator, a demodulation is carried out by a modulatable detector which is modulated by the modulation frequency.

6. (Original) The arrangement according to claim 1, wherein the light source is a short-pulse laser.

7. (Original) The arrangement according to claim 1, wherein the laser is also used for at least one of multiphoton excitation and SHG excitation.

8. (Original) The arrangement according to claim 1, wherein the modulator is an acousto-optic modulator or electro-optic modulator.

9. (Original) The arrangement according to claim 1, wherein a retroreflector is provided in the interferometer beam path for adapting the optical path length.

10. (Original) A method for operation of an arrangement according to claim 10, comprising the steps of:
using the LSM for single-photon fluorescence imaging; and/or multiphoton fluorescence imaging; and
using the heterodyne detection for referencing the fluorescence to regions deep in the specimen.

11. (Original) The method according to claim 10, wherein LSM images and heterodyne images are recorded simultaneously.

12. (Original) The method according to claim 10, wherein the LSM image and the heterodyne image are superimposed.

13. (Original) The method according to claim 10, wherein reference points of the specimen are used to orient the specimen with respect to three-dimensional image stacks of the LSM.

14. (Original) The method according to claim 10, wherein reference points of the specimen are used for orientation thereof in image recordings of temporal processes.

15. (Original) An interferometric measurement arrangement for heterodyne detection, for use in an arrangement which comprises an interferometer arrangement and an optical modulator for fast modulation which is provided in an interferometer arm of the interferometer arrangement for heterodyne detection, said measurement arrangement comprising:
a dispersive unit provided in at least one interferometer arm, which dispersive unit splits the light into its spectral component parts and recombines these component parts;
imaging optics which image the spectral components in a focal plane within the dispersive unit; and
a light manipulator which changes the phase and/or amplitude of the spectral components being arranged in or in the vicinity of the focal plane.

16. (Original) The interferometric measurement arrangement according to claim 15 including the step of using said arrangement for adapting dispersion.

17. (Original) The interferometric measurement arrangement according to claim 15 including the step of using said arrangement for compensating dispersion when a short-pulse laser is coupled into an LSM.
